(19) United States
(12) Patent Application Publication
(10) Pub. No.: US 2025/0324130 A1
(43) Pub. Date: Oct. 16, 2025

(54) METHOD AND DEVICE FOR EXTRACTING INFORMATION FROM VIDEO DATA AND ANALYZING SAME

(71) Applicant: NCSOFT Corporation, Seoul (KR)

(72) Inventors: Hyeokjun KIM, Seongnam-si (KR); Sanghoon BYUN, Seongnam-si (KR); Dongkyu LEE, Seongnam-si (KR)

(73) Assignee: NCSOFT Corporation, Seoul (KR)

(21) Appl. No.: 19/252,371

(22) Filed: Jun. 27, 2025

Related U.S. Application Data
(63) Continuation of application No. PCT/KR2023/001455, filed on Feb. 1, 2023.

(51) Int. Cl. H04N 21/431; G06F 16/34; G06F 40/166; G10L 15/26; H04N 21/439

(52) U.S. Cl. CPC H04N 21/4316; G06F 16/345; G06F 40/166; G10L 15/26; H04N 21/4394

(57) ABSTRACT

A device and method for extracting and analyzing information from video data includes obtaining video data; detecting speech uttered within the video data to generate text data for the video data, the text data comprising a speech text of the video data, generating summary data for the video data based on the text data, generating trend data for the video data based on tag data; and displaying information about the video data.

### CROSS-REFERENCE TO RELATED APPLICATION

This application is a continuation application of International Application No. PCT/KR2023/001455, filed on Feb. 1, 2023, the disclosure of which is incorporated by reference herein in its entirety.

### BACKGROUND

### 1. Field

The present disclosure relates to a method and device for extracting information from video data and analyzing same.

### 2. Description of Related Art

With the advancement of internet and display technologies and the widespread adoption of smart phones, people increasingly consume audio and video content, finding it more accessible and offering a wider selection compared to conventional media like books or newspapers.

While consumed video content includes movies, dramas, and television (TV) broadcasts, nowadays anyone may easily create and upload videos, and some of them achieve influence comparable to celebrities and are often referred to as influencers, signifying their influential status.

Influencers create and upload videos based on diverse topics, and depending on the influence of the influencers and the topics they cover, the viewership of these videos may change rapidly, and the videos created and uploaded by influencers may significantly impact viewers. Therefore, for example, when an influencer covers specific content (e.g., a game), individuals or companies associated with the content (e.g., game developers or publishers) may need to monitor the videos created and uploaded by the influencer.

However, as the number of people producing and uploading videos grows, and the variety of content consumed and mentioned within these videos increases, manually analyzing video data and generating corresponding analysis results may be challenging.

### SUMMARY

The present disclosure relates to a method and device for extracting information from video data and analyzing same. Technical aspects of the present disclosure are not limited to the foregoing, and other unmentioned objects or features of the present disclosure would be understood from the following description and be more clearly understood from the embodiments of the present disclosure. In addition, it would be appreciated that the aspects and features of the present disclosure may be implemented by means provided in the claims and a combination thereof.

According to an aspect of the disclosure, there is provided a method of extracting and analyzing information from video data, the method including: obtaining video data; detecting speech uttered within the video data to generate text data for the video data, the text data including a speech text of the video data; generating summary data for the video data based on the text data; generating trend data for the video data based on tag data; and displaying information about the video data.

The method may include identifying a video category to which the video data belongs, from among one or more preset video categories, wherein the tag data may be set based on the video category to which the video data belongs.

The generating of the summary data may include generating the summary data based on keyword data, and wherein the keyword data may be generated based on one or more words detected in the speech text a threshold number of times or more.

The generating of the trend data may include: detecting, in the speech text included in the text data, a word similar to a first tag included in the tag data; generating modified text data by replacing the similar word with the first tag; and generating the trend data for the video data based on the modified text data.

Based on the uttered speech being associated with a plurality of speakers, the text data may include information about a speaker corresponding to the speech text among the plurality of speakers.

The method may include generating an interface configured to display the information about the video data.

The interface for displaying information about the video data may include a text extraction interface, and the text extraction interface may include a video playback interface configured to display the video data, a text data interface configured to display the text data, and a summary data interface configured to display the summary data.

The video playback interface may be configured to, based on obtaining an input of interacting with a first timestamp object included in the text data interface or the summary data interface, play back a video starting from a time point corresponding to the first timestamp object.

The interface for displaying information about the video data may include a trend analysis interface, and the trend analysis interface may include a video playback interface configured to display the video data, a trend data interface configured to display the trend data, and a summary data interface configured to display the summary data.

According to an aspect of the disclosure, there is provided a non-transitory computer-readable recording medium having recorded thereon a program for causing a computer to execute a method including: obtaining video data; detecting speech uttered within the video data to generate text data for the video data, the text data including a speech text of the video data; generating summary data for the video data based on the text data; and generating trend data for the video data based on tag data; and displaying information about the video data.

According to an aspect of the disclosure, there is provided a device for extracting and analyzing information from video data, the device including: a memory storing at least one instruction; and a processor configured to execute the at least one instruction to cause the device to: obtain the video data; detect speech uttered within the video data to generate text data for the video data, the text data including a speech text of the video data; generate summary data for the video data based on the text data; generate trend data for the video data based on tag data; and display information about the video data. 1

The processor may be further configured to execute the at least one instruction to cause the device to: identify a video category to which the video data belongs, from among one or more preset video categories, and wherein the tag data may be set based on the video category of the video data.

The processor may be further configured to execute the at least one instruction to cause the device to: generate the summary data based on keyword data, and generate the keyword data based on one or more words detected in the speech text a threshold number of times or more.

The processor may be further configured to execute the at least one instruction to cause the device to: detect, in the speech text included in the text data, a word similar to a first tag included in the tag data; and generate modified text data by replacing the similar word with the first tag; and generate the trend data for the video data based on the modified text data.

Based on the uttered speech being associated with a plurality of speakers, the text data may include information about a speaker corresponding to the speech text among the plurality of speakers.

The processor may be further configured to execute the at least one instruction to cause the device to generate an interface configured to display the information about the video data.

The interface for displaying information about the video data may include a text extraction interface, and wherein the text extraction interface may include a video playback interface configured to play back the video data, a text data interface configured to display the text data, and a summary data interface configured to display the summary data.

The video playback interface may be configured to, based on obtaining an input of interacting with a first timestamp object included in the text data interface or the summary data interface, play back a video starting from a time point corresponding to the first timestamp object.

The interface for displaying information about the video data may include a trend analysis interface, and wherein the trend analysis interface may include a video playback interface configured to display the video data, a trend data interface configured to display the trend data, and a summary data interface configured to display the summary data.

According to an embodiment of the present disclosure, only necessary information may be effectively extracted from numerous pieces of video data, and processed data useful for summary and trend analysis regarding various video producers may be generated.

In addition, an interface allowing effective understanding of processed data may be provided, exhibiting usefulness in terms of identifying trends.

In particular, a tool that maximizes work efficiency may be provided to individuals tasked with monitoring reactions of consumers on developed products.

In addition, various embodiments of the present disclosure may be appropriately modified in any manner according to the type of content (e.g., games, movies, food, or manufactured goods), and thus may be utilized across various industries.

### BRIEF DESCRIPTION OF THE DRAWINGS

The above and other aspects and/or features of one or more embodiments of the disclosure will be more apparent from the following detailed description, taken in conjunction with the accompanying drawings, in which:

FIG. 1 is a diagram illustrating an example of an analysis system including devices and a control server;

FIG. 2 is a diagram schematically illustrating operations of a device for extracting and analyzing information from video data, according to an embodiment of the present disclosure;

FIG. 3 is a schematic diagram for describing an operation of generating text data, according to an embodiment of the present disclosure;

FIG. 4 is a schematic diagram for describing an operation of generating trend data, according to an embodiment of the present disclosure;

FIG. 5 is a flowchart for describing a method of providing an interface, according to an embodiment of the present disclosure;

FIG. 6 is a diagram illustrating a function selection interface according to an embodiment of the present disclosure;

FIG. 7 is a diagram illustrating a data input interface according to an embodiment of the present disclosure;

FIG. 8 is a diagram illustrating a text extraction interface according to an embodiment of the present disclosure;

FIG. 9 is a diagram illustrating a multi-summary interface according to an embodiment of the present disclosure;

FIG. 10 is a diagram illustrating a trend analysis interface according to an embodiment of the present disclosure;

FIG. 11 is a flowchart of a method of extracting and analyzing information from video data, according to an embodiment of the present disclosure; and

FIG. 12 is a block diagram of a device for extracting and analyzing information from video data, according to an embodiment of the present disclosure.

### DETAILED DESCRIPTION

A method according to an embodiment of the present disclosure may include receiving (e.g., obtaining) video data, detecting speech uttered within the video data to generate text data for the video data, the text data including a speech text of the video data, generating summary data for the video data based on the text data, and generating trend data for the video data based on tag data.

Aspects and features of the present disclosure and a method for achieving them will be apparent with reference to embodiments of the present disclosure described below together with the attached drawings. The present disclosure may, however, be embodied in many different forms and should not be construed as being limited to the embodiments set forth herein, and all changes, equivalents, and substitutes that do not depart from the spirit and technical scope of the present disclosure are encompassed in the present disclosure.

Terms used herein are for describing embodiments and are not intended to limit the scope of the present disclosure. The singular expression also includes the plural meaning as long as it is not inconsistent with the context. In the present specification, it is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Some embodiments of the present disclosure may be represented by functional block components and various processing operations. Some or all of the functional blocks may be implemented by any number of hardware and/or software elements that perform particular functions. For example, the functional blocks of the present disclosure may be embodied by at least one microprocessor or by circuit components for a certain function. In addition, for example, the functional blocks of the present disclosure may be implemented by using various programming or scripting languages. The functional blocks may be implemented by using various algorithms executable by one or more processors. In addition, the present disclosure may employ known technologies for electronic settings, signal processing, and/or data processing. Terms such as “mechanism”, “element”, “unit”, or “component” are used in a broad sense and are not limited to mechanical or physical components.

In addition, connection lines or connection members between components illustrated in the drawings are merely exemplary of functional connections and/or physical or circuit connections. Various alternative or additional functional connections, physical connections, or circuit connections between components may be present in a practical device.

Hereinafter, an operation performed by a user may refer to an operation performed by the user through a user terminal. For example, a command corresponding to an action performed by the user may be input to the user terminal through an input device (e.g., a keyboard or a mouse) embedded in or additionally connected to the user terminal. As another example, a command corresponding to an action performed by the user may be input to the user terminal through a touch screen of the user terminal. Here, the action performed by the user may include a certain gesture. For example, gestures may include tap, touch and hold, double-tap, drag, panning, flick, drag and drop, and the like.

Hereinafter, the present disclosure will be described in detail with reference to the accompanying drawings.

In the present disclosure, video data may be understood as data including a video that includes one or more frames, and audio data corresponding to the video, and may also refer to data including only audio data.

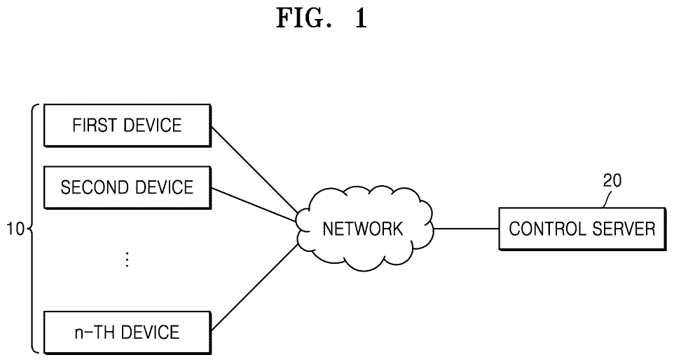

FIG. 1 is a diagram illustrating an example of an analysis system including devices and a control server.

An analysis system according to an embodiment may include devices 10 and a control server 20. FIG. 1 illustrates only components of the analysis system that are associated with an embodiment. Thus, other components may be further included in the analysis system in addition to the components illustrated in FIG. 1.

The devices 10 and the control server 20 may perform communication by using a network. For example, the network may include a local area network (LAN), a wide area network (WAN), a value-added network (VAN), a mobile radio communication network, a satellite communication network, and a combination thereof, may be a comprehensive data communication network that allows each network constituent entity illustrated in FIG. 1 to perform seamless communication with each other, and may include a wired Internet network, a wireless Internet network, and a mobile wireless communication network. In addition, the wireless communication may include, but is not limited to, a wireless LAN (e.g., Wi-Fi), Bluetooth, Bluetooth Low Energy, Zigbee, Wi-Fi Direct (WFD), ultra-wideband (UWB), Infrared Data Association (IrDA), and near-field communication (NFC).

In the present disclosure, the devices 10 may include any device capable of generating video data, or uploading generated or stored video data to or via a network. For example, the device 10 may be, but is not limited to, a smart phone, a tablet personal computer (PC), a PC, a smart television (TV), a mobile phone, a personal digital assistant (PDA), a laptop computer, a media player, a microserver, a global positioning system (GPS) device, an electronic book terminal, and a digital broadcasting terminal, a navigation system, a kiosk, an MP3 player, a digital camera, a home appliance, a device equipped with a camera, or any one of other mobile or nonmobile computing devices.

Although FIG. 1 illustrates that the device 10 transmits data directly to the control server 20 via the network, this illustration should be understood as explaining that the control server 20 may receive and collect video data in various manners and extract and analyze information from the video data, and as will be described below, the control server 20 may receive video data in any suitable manner.

The control server 20 may receive data transmitted from the device 10 via the network. The control server 20 may perform information extraction and analysis according to the present disclosure, based on the received data. The control server 20 may provide an analysis result to a user (e.g., an administrator) of the control server 20.

The control server 20 may be, but is not limited to, a smart phone, a tablet PC, a PC, a smart TV, a mobile phone, a PDA, a laptop computer, a media player, a microserver, a GPS device, an electronic book terminal, a digital broadcasting terminal, a navigation system, a kiosk, an MP3 player, a digital camera, a home appliance, a camera-equipped device, a wearable device having communication and data processing capabilities, such as glasses or a hair band, or other mobile or non-mobile computing devices, and the control server 20 may include any type of device capable of communicating with other devices via a network.

The control server 20 may include a touch screen serving as a touch input unit. The touch screen refers to a screen on which certain information may be input through a gesture of a user, and examples of gestures of the user may include tap, double tap, press (touch-and-hold), long press, drag, panning, flick, drag-and-drop, release, and the like.

The control server 20 may be implemented as a computer device or a plurality of computer devices that provide a command, code, a file, content, a service, and the like by performing communication via a network.

Hereinafter, methods of extracting and analyzing information from video data according to various embodiments of the present disclosure relate to operations performed by a device for extracting and analyzing information from video data (hereinafter, referred to as a “video analysis device”), and the video analysis device for performing operations according to various embodiments may be the control server 20 or a part thereof.

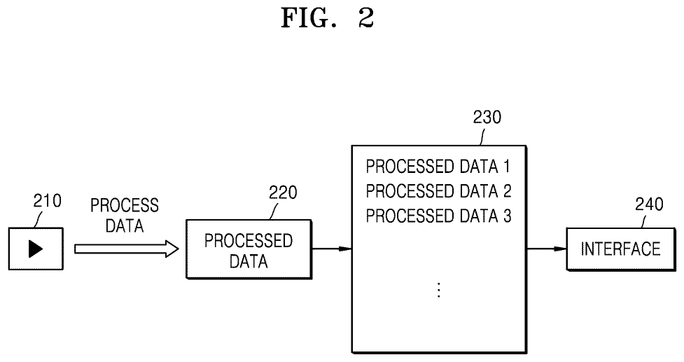

FIG. 2 is a diagram schematically illustrating operations of a device for extracting and analyzing information from video data, according to an embodiment of the present disclosure.

In the present disclosure, a video analysis device may receive video data 210.

The video data 210 may be received through various methods. For example, the video data 210 may be input via any suitable means (e.g., a universal serial bus (USB) storage device) by a user (e.g., an administrator) of the video analysis device. As another example, the video data 210 may be downloaded by the video analysis device. For example, when the user of the video analysis device inputs a uniform resource locator (URL) of a video, the video analysis device may download video data corresponding to the URL. As another example, the video data 210 may be automatically collected by the video analysis device. For example, the video data 210 may be uploaded by a specific user (identified by a corresponding account) or a specific device, and the video analysis device may collect the uploaded video data 210 in real time via the network.

In the present disclosure, the video analysis device may process the video data 210 to generate processed data 220. In detail, the video analysis device may generate the processed data 220 by extracting desired information from the video data 210. In an embodiment, the processed data 220 may include text data, summary data, trend data, and the like, which will be described below. The video analysis device may provide analysis data about the video data 210 based on the processed data 220.

In the present disclosure, the video analysis device may generate a processed data set 230 based on the processed data 220. Referring to FIG. 2, the processed data set 230 may include processed data 1, processed data 2, processed data 3, and the like. The pieces of processed data included in the processed data set 230 may be generated based on different pieces of video data, respectively. That is, in the present disclosure, the processed data set 230 may refer to a data set including pieces of processed data corresponding to a plurality of pieces of video data, respectively. The video analysis device may generate the processed data 220 for the video data 210 to provide analysis information about the video data 210, and may also provide analysis information associated with other video data through comparison or contrast with the processed data set 230. The video analysis device may include, in the processed data set 230, the processed data 220.

In the present disclosure, the video analysis device may generate an interface 240 based on the processed data 220 or the processed data set 230. That is, the video analysis device may generate the interface 240 to provide the user of the video analysis device with the processed data 220, which is analysis information about the video data 210, or the processed data set 230, which is analysis information associated with other video data than the video data 210. In an embodiment, the video analysis device may provide the generated interface 240 to the user of the video analysis device through various methods. For example, the video analysis device may display the interface 240 via any display device.

Hereinafter, specific embodiments will be described in which the video analysis device generates processed data based on video data.

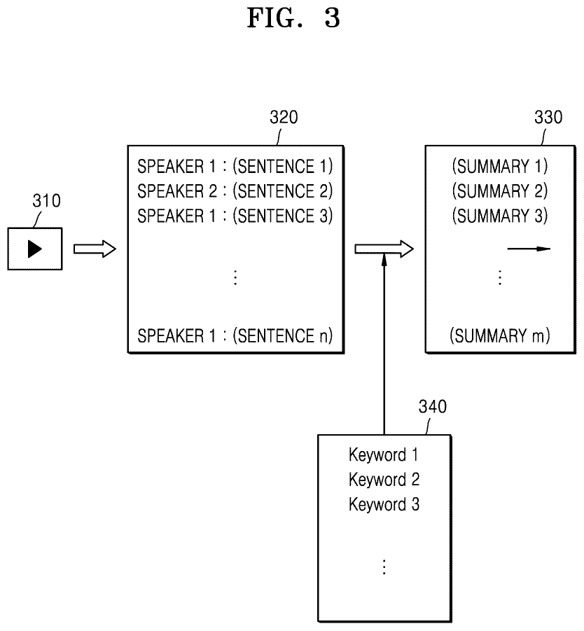

FIG. 3 is a schematic diagram for describing an operation of generating text data, according to an embodiment of the present disclosure.

In an embodiment, the video analysis device may generate text data 320 based on video data 310. The video data 310 may correspond to the video data 210 described above.

In detail, the video analysis device may detect speech uttered within the video data 310. The video analysis device may detect speech uttered within the video data 310 via any suitable speech recognition means, so as to generate a speech text. The speech text may refer to a text representation of a language spoken by a speaker within the video data 310. The video analysis device may generate the text data 320 based on the speech text.

In an embodiment, when speech uttered within the video data 310 is associated with a plurality of speakers, the text data 320 may include information about the speaker corresponding to the speech text. That is, when a plurality of speakers speak within the video data 310, speaker information and corresponding a speech text may be matched with each other and then stored as the text data 320.

Referring to FIG. 3, as the video data 310 is associated with speaker 1 and speaker 2, the text data 320 may be generated to include sentence 1, sentence 2, sentence 3, . . . , sentence n, each matched with speaker 1 or speaker 2.

In an embodiment, the text data 320 may include timestamps corresponding to time points in the video data 310. In detail, the text data 320 may include timestamps corresponding to time points within the video data 310, and speech texts corresponding to the timestamps. For example, when a speaker within the video data 310 utters sentence 1 at the time point of 3 minutes and 25 seconds within the video data 310, the text data 320 may include a timestamp “03:25” and a speech text “sentence 1” corresponding to “03:25”. That is, a timestamp and a speech text may be matched with each other and then stored as the text data 320. A timestamp may be matched with one or more speech texts.

In an embodiment, the video analysis device may generate summary data 330 based on the text data 320. In the present disclosure, the summary data 330 may refer to data that includes the core content of the video data 310 that is based on the text data 320, to allow the video analysis device to readily identify core information. The video analysis device may generate the summary data 330 through any suitable method.

In an embodiment, the summary data 330 may include one or more summaries. Referring to FIG. 3, the summary data 330 may include summary 1, summary 2, . . . , summary m.

In an embodiment, the summary data 330 may also include timestamps corresponding to time points within the video data 310. Because the summary data 330 is generated based on the text data 320, timestamps included in the text data 320 may be reflected in the summary data 330.

In an embodiment, the video analysis device may generate the summary data 330 based on the text data 320 and keyword data 340. The keyword data 340 refers to data including words and the like that are useful in analyzing the video data 310, and may serve as criteria for generating the summary data 330 from the text data 320. That is, the keyword data 340 may serve as criteria for identifying core information among information included in the text data 320. The keyword data 340 may be preset by the video analysis device. Alternatively, the keyword data 340 may be set by the user of the video analysis device. For example, the user of the video analysis device may input the keyword data 340 into the video analysis device.

In an embodiment, the keyword data 340 may be extracted from the text data 320 or a speech text. In an embodiment, the keyword data 340 may be generated based on one or more words detected in a speech text a threshold number of times or more. That is, the video analysis device may select one or more words that appear frequently in the speech text, and determine (e.g., identify), as the keyword data 340, a data set including the selected one or more words.

In an embodiment, the keyword data 340 may be set based on a video category (to be described below) of the video data 310. In detail, the keyword data 340 may be matched with the video category and then stored, and may be automatically set corresponding to the video category, to be reflected in the generation of the summary data 330.

In an embodiment, the keyword data 340 may be set based on a main speaker of the video data 310. In detail, the keyword data 340 may be preset data based on the main speaker of the video data 310, such as a content user or a gamer. The keyword data 340 may be generated based on language habits, consumed content, content consumption patterns, and trends of the main speaker of the video data 310, and the generated keyword data 340 may be matched with the main speaker of the video data 310 and then stored, and when performing analysis on the video data 310, may be automatically retrieved and reflected by the video analysis device.

In an embodiment, the keyword data 340 may include one or more keywords. Referring to FIG. 3, the keyword data 340 may include Keyword 1, Keyword 2, Keyword 3, and the like.

In the example illustrated in FIG. 3, based on Keyword 1, Keyword 2, Keyword 3, and the like, included in the keyword data 340, core content may be derived by selecting from among sentence 1, sentence 2, sentence 3, . . . , sentence n included in the text data 320, or by combining one or more of sentence 1, sentence 2, sentence 3, . . . , sentence m, and the derived core content may include summary 1, summary 2, . . . , summary m included in the summary data 330.

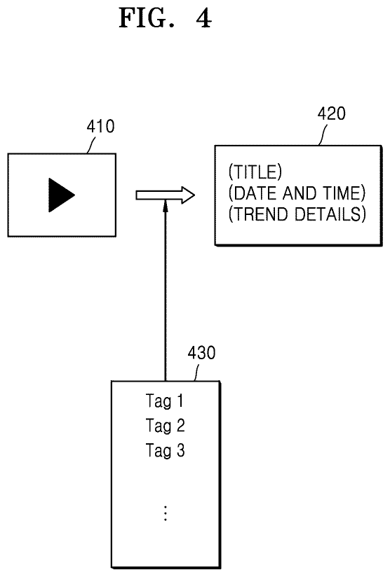

FIG. 4 is a schematic diagram for describing an operation of generating trend data, according to an embodiment of the present disclosure.

In the present disclosure, trend data may refer to data about trends including activities, achievements, achievement levels, task stages, and the like, which are identified based on content performed or provided by a speaker within video data. Through the trend data, the user of the video analysis device of the present disclosure may identify the recent activities of a speaker (e.g., a content user or a gamer) in relation to content within a video, and when trend data about a plurality of pieces of video data is obtained, the user may analyze activities of various speakers, overall trends, and the like regarding the same content.

In an embodiment, the video analysis device may generate trend data 420 based on video data 410. The video data 410 may correspond to the video data 210 or the video data 310 described above. That is, the trend data 420 may also include data generated based on other data generated based on the video data 410, such as the text data 320 or the summary data 330 described above.

In an embodiment, the trend data 420 may include at least one of a title of the video data 410, an uploader name, a date and time associated with the video data 410 (i.e., upload or creation time), and details of a trend.

In an embodiment, the trend data 420 may include the text data 320 or the summary data 330 generated based on video data, which satisfies a specific condition.

In an embodiment, the video analysis device may generate the trend data 420 based on the video data 410 and/or tag data 430. Here, an operation, performed by the video analysis device, of generating the trend data 420 based on the video data 410 and/or the tag data 430 may include matching the tag data 430 with the video data 410 and/or with the text data 320 or the summary data 330 generated based on the video data 410. In other words, the trend data 420 may be generated based on data that is matched with the tag data 430, among the video data 410 and/or the text data 320 or the summary data 330.

The tag data 430 refers to data including words and the like that are useful in analyzing trends in the video data 410, and may serve as criteria for generating the trend data 420 from the video data 410. The tag data 430 may be preset by the video analysis device. Alternatively, the tag data 430 may be set by the user of the video analysis device. For example, the user of the video analysis device may input the tag data 430 into the video analysis device.

Compared to the keyword data 340 described above, the keyword data 340 needs to be set to generate the summary data 330 that reflects suitable and accurate summaries from the text data 320, whereas the tag data 430 needs to be set to generate the trend data 420 that reflects activities, trends, and the like, of a speaker such as a content user or a gamer, and thus, to achieve these different purposes, the tag data 430 and the keyword data 340 may be set based on different principles.

In an embodiment, the tag data 430 may be set based on a video category (to be described below) of the video data 410. In detail, the tag data 430 may be matched with the video category and then stored, and may be automatically set corresponding to the video category, to be reflected in the generation of the trend data 420.

Generating the trend data 420 based on the tag data 430 may enable the user of the video analysis device to analyze trends of a speaker in video data, or of speakers in a plurality of pieces of video data, according to a trend concept that the user wishes to identify. In particular, when the tag data 430 is set based on a video category, the same criteria are applied to one or more pieces of video data belongs to the same video category, enabling objective and effective trend identification.

In addition, during a process of detecting uttered speech, an undesired speech text may be generated due to technical imperfections in speech recognition or the use of abbreviations, and accordingly, text data, summary data, trend data, and the like may be generated inappropriately, or data of the desired quality may not be generated. To address these issues, in an embodiment, the video analysis device may generate trend data by modifying a speech text or text data.

In detail, in an embodiment, the video analysis device may detect, in text data or a speech text, a word similar to any one (hereinafter, referred to as a “first tag”) of one or more tags included in the tag data. The tag data is data including words and the like that are useful in trend analysis, and thus may be used as a useful clue in data processing. In an embodiment, the video analysis device may generate modified text data by replacing the detected similar word with the first tag. In an embodiment, the video analysis device may generate trend data based on the modified text data. In addition, the similarity between the first tag and a specific word may be calculated by using any suitable method.

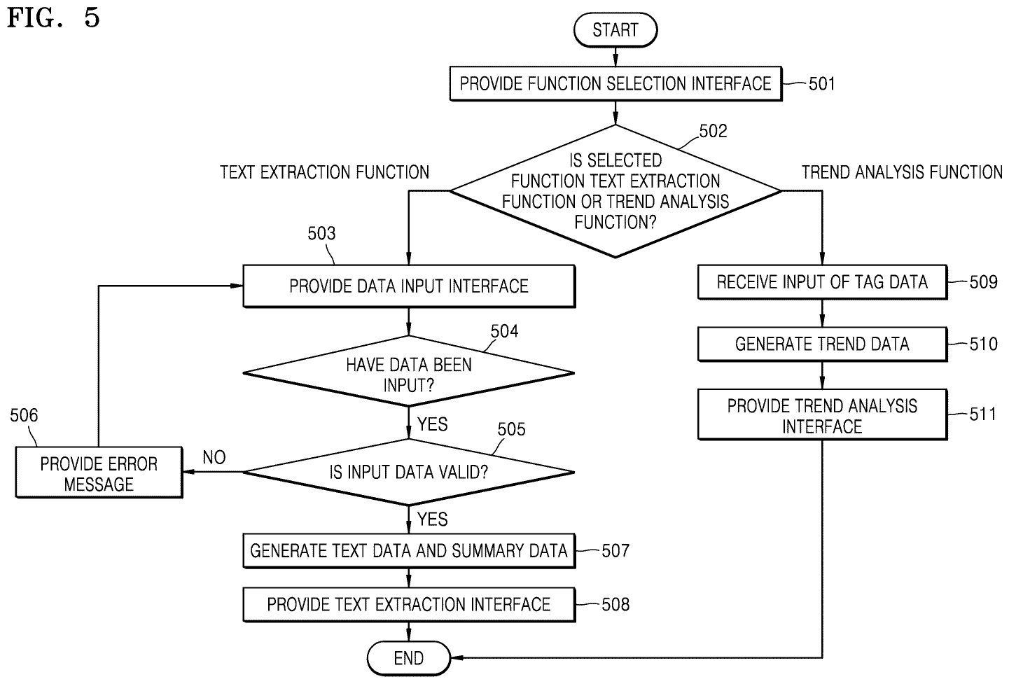

FIG. 5 is a flowchart for describing a method of providing an interface, according to an embodiment of the present disclosure.

In the present disclosure, the video analysis device may generate an interface for displaying information about video data, and provide the generated interface to the user of the video analysis device. FIG. 5 illustrates a method or procedure of providing an interface that may provide a user of a video analysis device with a guide for conveniently using a video analysis function, and convenience in browsing processed data to obtain desired information.

In an embodiment, the video analysis device may provide a function selection interface (501). The function selection interface may refer to an interface configured to request a selection from the user of the video analysis device to provide any one of the functions provided by the video analysis device, and receive a function selection input from the user.

In an embodiment, the video analysis device may determine whether the selected function is a text extraction function or a trend analysis function (502). In an embodiment, the video analysis device may determine, based on the function selection input from the user of the video analysis device, whether the selected function is the text extraction function or the trend analysis function.

In an embodiment, when the selected function is the text extraction function, the video analysis device may provide a data input interface (503).

In an embodiment, the video analysis device may determine whether data has been input (504). In an embodiment, the user of the video analysis device may input data via the data input interface.

In an embodiment, when data is input, the video analysis device may determine whether the input data is valid (505). For example, the video analysis device may determine whether the input data is analyzable.

In an embodiment, when the input data is not valid, the video analysis device may provide an error message (506). The error message may include any suitable message notifying the user of the video analysis device that the input data is incorrect. In an embodiment, the error message may be provided differently depending on the reason why the input data is not valid. For example, when the format of the input data is incorrect, the error message may include a message indicating that the format of the data is incorrect or a message providing guidance on supported data formats. For example, when the input data does not exist, the error message may include a message indicating that the data does not exist.

In an embodiment, when the input data is valid, the video analysis device may generate text data and summary data (507). The video analysis device may generate text data and summary data based on the input data, and may perform a process of generating text data and summary data according to various embodiments described above.

In an embodiment, the video analysis device may provide a text extraction interface (508). The video analysis device may generate the text extraction interface based on the generated text data and summary data.

In an embodiment, when the selected function is the trend analysis function, the video analysis device may receive an input of tag data (509). In an embodiment, the tag data may be preset and may be automatically input (e.g., retrieved from a database) by the video analysis device. In another embodiment, the tag data may be manually input by the user. In an embodiment, the video analysis device may provide an interface for receiving an input of tag data from the user.

In an embodiment, the video analysis device may generate trend data (510). The video analysis device may generate trend data based on the received tag data. The video analysis device may perform a process of generating trend data according to various embodiments described above.

In an embodiment, the video analysis device may provide a trend analysis interface (511). The video analysis device may generate the trend analysis interface based on the generated trend data.

In addition, to provide convenience for the user of the video analysis device in using a video analysis function and in browsing processed data, other procedures than those illustrated in FIG. 5 may be added, some of the procedures illustrated in FIG. 5 may be omitted, or the order of the procedures illustrated in FIG. 5 may be changed. For example, before the user of the video analysis device selects a function of the video analysis device, an operation in which the user inputs data may be performed. In addition, although FIG. 5 does not illustrate a process of inputting data when the trend analysis function is selected, the video analysis device, when performing the trend analysis function, may generate trend data based on a data pool (e.g., automatically collected from a network or preset), and an operation of receiving an input of data (e.g., via provision of a data input interface) may be additionally performed before the trend data is generated.

Hereinafter, embodiments associated with the configuration of various interfaces described above will be described.

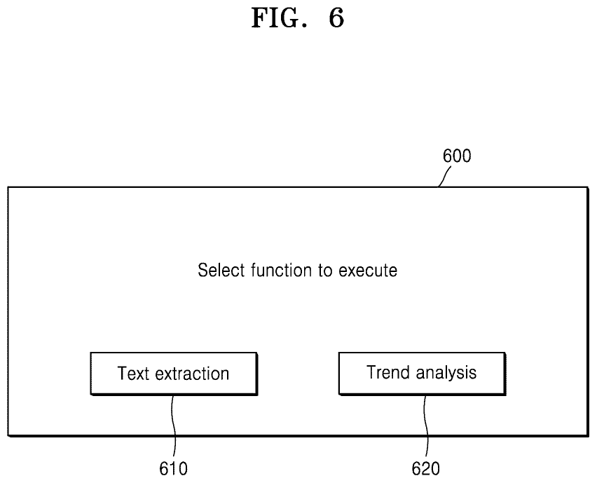

FIG. 6 is a diagram illustrating a function selection interface according to an embodiment of the present disclosure.

As described above with reference to FIG. 5, the video analysis device may provide a function selection interface.

The user of the video analysis device may transmit a function selection input via a function selection interface 600. In an embodiment, the user of the video analysis device may transmit a function selection input via an object included in the function selection interface 600.

In an embodiment, the function selection interface 600 may include a text extraction function object 610 and a trend analysis function object 620. The user of the video analysis device may interact with the text extraction function object 610 to cause the video analysis device to perform a text extraction function. The user of the video analysis device may interact with the trend analysis function object 620 to cause the video analysis device to perform a trend analysis function.

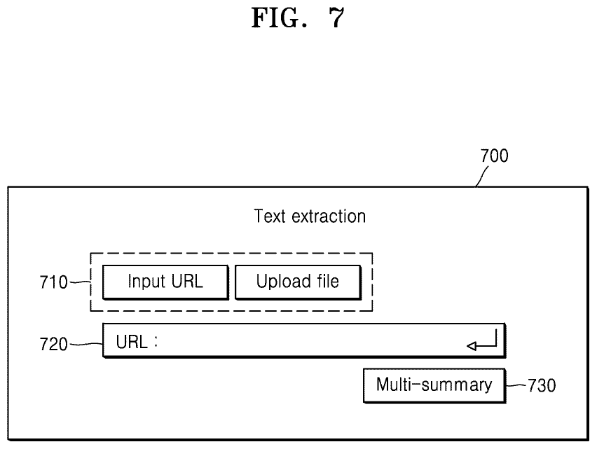

FIG. 7 is a diagram illustrating a data input interface according to an embodiment of the present disclosure.

As described above with reference to FIG. 5, when the selected function is the text extraction function, the video analysis device may provide a data input interface.

The user of the video analysis device may input data via a data input interface 700. In detail, the user of the video analysis device may set a data input method via a data input method setting interface 710, and input data via a data input interface 720 based on the set data input method.

In an embodiment, the data input method setting interface 710 may refer to an interface for setting a method of inputting data. In the example illustrated in FIG. 7, the user of the video analysis device may determine, via the data input method setting interface 710, whether to input data via URL input or via file upload, and the data input method setting interface 710 may be appropriately configured for the user of the video analysis device to select an input method. In the example illustrated in FIG. 7, the user of the video analysis device may have selected a URL input method by interacting with an object labeled “URL Input”, to input data via URL input.

In an embodiment, the data input interface 720 may refer to an interface for inputting data based on the set input method. The user of the video analysis device may input data via the data input interface 720 based on the set input method. The data input interface 720 may be configured to be displayed differently depending on the set data input method. In the example illustrated in FIG. 7, in response to (e.g., based on) the user of the video analysis device selecting the URL input method, the data input interface 720 may be configured to be displayed to enable input of a URL address. In an embodiment, when the user of the video analysis device interacts with the data input interface 720, the video analysis device may provide an additional interface (e.g., an interface in a pop-up form), so as to allow the user to input data. For example, when the data input method is set to a file upload method, an explorer interface capable of browsing a file directory may be configured to be additionally displayed.

In an embodiment, the user of the video analysis device may invoke a multi-summary function by interacting with a multi-summary function invocation object 730. In response to the user of the video analysis device interacting with the multi-summary function invocation object 730, the video analysis device may generate multiple summaries including input data. The video analysis device may generate a multi-summary interface (to be described below) based on the generated multiple summaries.

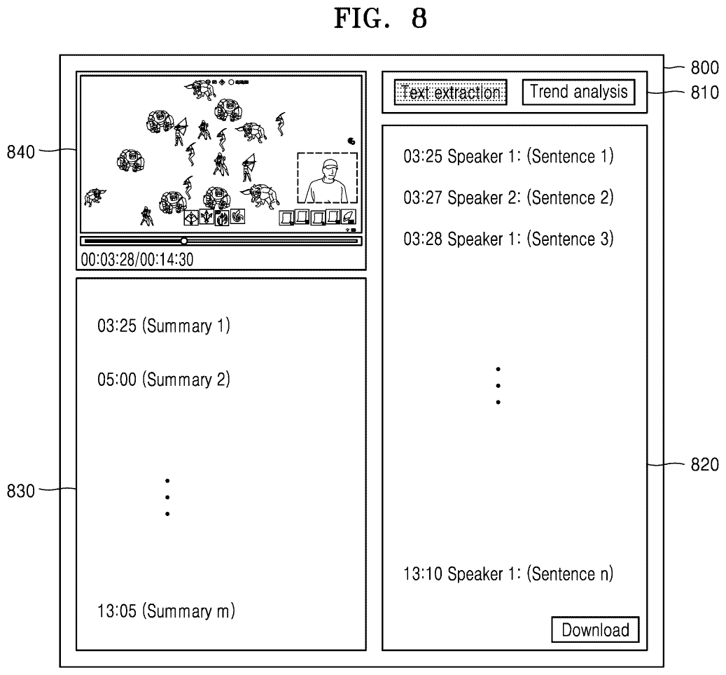

FIG. 8 is a diagram illustrating a text extraction interface according to an embodiment of the present disclosure.

As described above with reference to FIG. 5, the video analysis device may generate text data and summary data based on input data, and generate a text extraction interface based on the generated text data and summary data.

In an embodiment, a text extraction interface 800 may include a function display interface 810.

In the present disclosure, the function display interface 810 may refer to an interface configured to allow identification of a function being provided via the displayed interface. The user of the video analysis device may identify which function is being provided via the function display interface 810. In the example illustrated in FIG. 8, the user of the video analysis device may discern that the displayed interface is for providing a text extraction function.

In an embodiment, the function display interface 810 may further include an object with which the user may interact to invoke another function of the video analysis device. That is, a function may be implemented to switch the function being provided via the function display interface 810. For example, although the function being provided to the user of the video analysis device is the text extraction function, the user may interact with an object included in the function display interface 810 to cause the video analysis device to perform a trend analysis function. In the example illustrated in FIG. 8, the function display interface 810 includes an object labeled “Trend analysis”, and the user of the video analysis device may interact with the object labeled “Trend analysis”, thereby causing the video analysis device to perform the trend analysis function. In this case, the video analysis device may perform a trend analysis process by using data previously input for the text extraction function as is.

In an embodiment, the text extraction interface 800 may include a text data interface 820.

In the present disclosure, the text data interface 820 may refer to an interface configured to display text data. The video analysis device may provide text data generated according to the embodiments described above, to the user of the video analysis device via the text data interface 820.

In an embodiment, the user of the video analysis device may download generated text data or summary data. For example, the text data interface 820 may include an object for invoking a download function. In the example illustrated in FIG. 8, the user of the video analysis device may download text data or summary data by interacting with an object labeled “Download” included in the text data interface 820.

In an embodiment, the text extraction interface 800 may include a summary data interface 830.

In the present disclosure, the summary data interface 830 may refer to an interface configured to display summary data. The video analysis device may provide summary data generated according to the embodiments described above, to the user of the video analysis device via the summary data interface 830.

In an embodiment, the user of the video analysis device may modify summary data. For example, the summary data interface 830 may include an object for invoking a summary data modification function. In response to the user of the video analysis device interacting with the object for invoking the summary data modification function, the video analysis device may grant the user permission to modify summary data, and generate and provide an interface for modifying summary data.

In an embodiment, the user of the video analysis device may cause keyword data serving as the basis for generation of summary data to be displayed or modify the keyword data. For example, the summary data interface 830 may include an object for invoking a keyword data display function or a keyword data modification function. In response to the user of the video analysis device interacting with the object for invoking the keyword data modification function, the video analysis device may grant the user permission to modify keyword data, and generate and provide an interface for modifying keyword data.

In an embodiment, the text extraction interface 800 may include a video playback interface 840.

In the present disclosure, the video playback interface 840 may refer to an interface configured to play back video data. The video analysis device may provide video data that has served as the basis for text data and summary data, to the user of the video analysis device via the video playback interface 840.

In an embodiment, the video playback interface 840 may play back a video based on an interaction with the text data interface 820 or the summary data interface 830. In detail, as illustrated in FIG. 8, the text data interface 820 or the summary data interface 830 may include one or more timestamp objects, and the user of the video analysis device may interact with any one of the one or more timestamp objects included in the text data interface 820 or the summary data interface 830. The video analysis device may play back the video from the time point corresponding to the timestamp object with which the user of the video analysis device has interacted. In the example illustrated in FIG. 8, in response to receiving an input from the user of the video analysis device interacting with a timestamp object labeled “03:28” included in the text data interface 820, the video analysis device may play back the video starting from the time point 03:28, on the video playback interface 840.

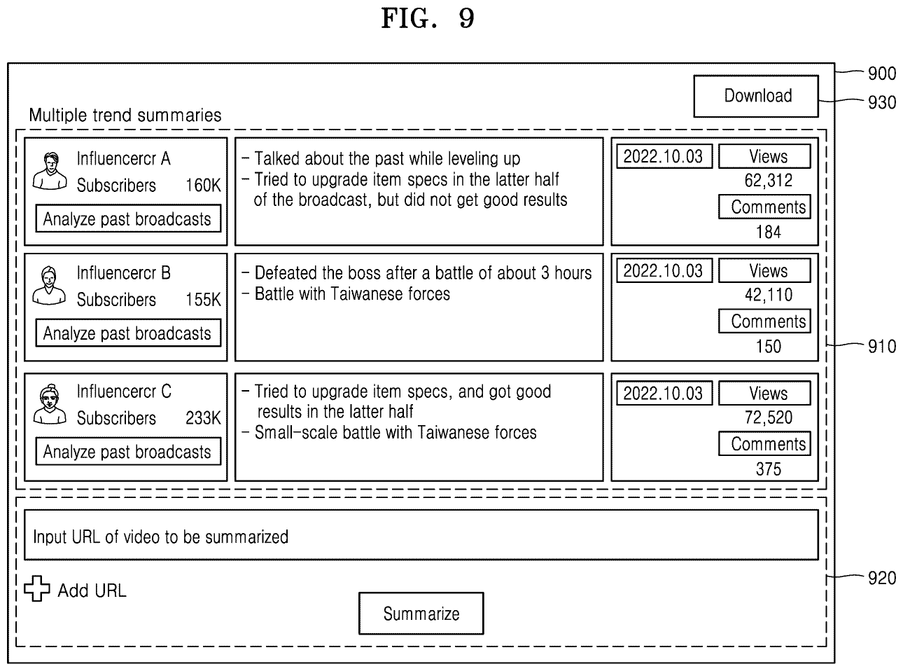

FIG. 9 is a diagram illustrating a multi-summary interface according to an embodiment of the present disclosure.

As described above, in an embodiment, the user of the video analysis device may invoke the multi-summary function by interacting with the multi-summary function invocation object 730 of FIG. 7. In response to the user of the video analysis device interacting with the multi-summary function invocation object 730, the video analysis device may generate multiple summaries including input data. The video analysis device may generate a multi-summary interface based on the generated multiple summaries.

In the present disclosure, the user of the video analysis device may check and manage information about trend data via the multi-summary interface.

In an embodiment, a multi-summary interface 900 may include a multi-trend interface 910.

In the present disclosure, the multi-trend interface 910 may refer to an interface configured to display a combination of pieces of trend data generated respectively for one or more pieces of video data. In the example illustrated in FIG. 9, pieces of trend data respectively generated for three pieces of video data are displayed. In an embodiment, the multi-trend interface 910 may include, for each piece of video data, information about the main speaker of the video data, trend details, date and time, information about the video data, and the like. In an embodiment, the multi-trend interface 910 may include a video data shortcut object for each piece of video data, and the user of the video analysis device may check the video data by interacting with the video data shortcut object.

In an embodiment, the multi-summary interface 900 may include a data addition interface 920.

In an embodiment, the user of the video analysis device may input video data via the data addition interface 920 so as to add new trend data to a trend data set. In an embodiment, the data addition interface 920 may include an object for initiating trend data generation, for example, the “Summarize” object of FIG. 9, and the user of the video analysis device may interact with the object for initiating trend data generation, to cause the video analysis device to initiate trend data generation based on input video data.

The video analysis device may generate trend data based on video data that is input via the data addition interface 920. Various embodiments described above may be applied to the trend data generation process. The video analysis device may add the generated new trend data to the trend data set, and cause the new trend data to be displayed on the multi-trend interface 910.

In an embodiment, the data addition interface 920 may be configured to allow setting of a data input method. The embodiments regarding the data input interface 700 described above with reference to FIG. 7 may be analogously applied. The user of the video analysis device may set the data input method, to add data via the data addition interface 920 in a desired manner.

In an embodiment, the multi-summary interface 900 may include a download function invocation object 930.

In an embodiment, the user of the video analysis device may download the trend data via the download function invocation object 930. In response to receiving an input from the user of the video analysis device interacting with the download function invocation object 930, the video analysis device may provide, in any suitable format, one or more pieces of trend data displayed on the multi-trend interface 910.

In an embodiment, the multi-summary interface 900 may further include a filter interface for setting conditions for trend data to be listed on the multi-trend interface 910. The user of the video analysis device may set listing conditions via the filter interface, such that only trend data for video data that satisfies the set conditions is displayed on the multi-trend interface 910.

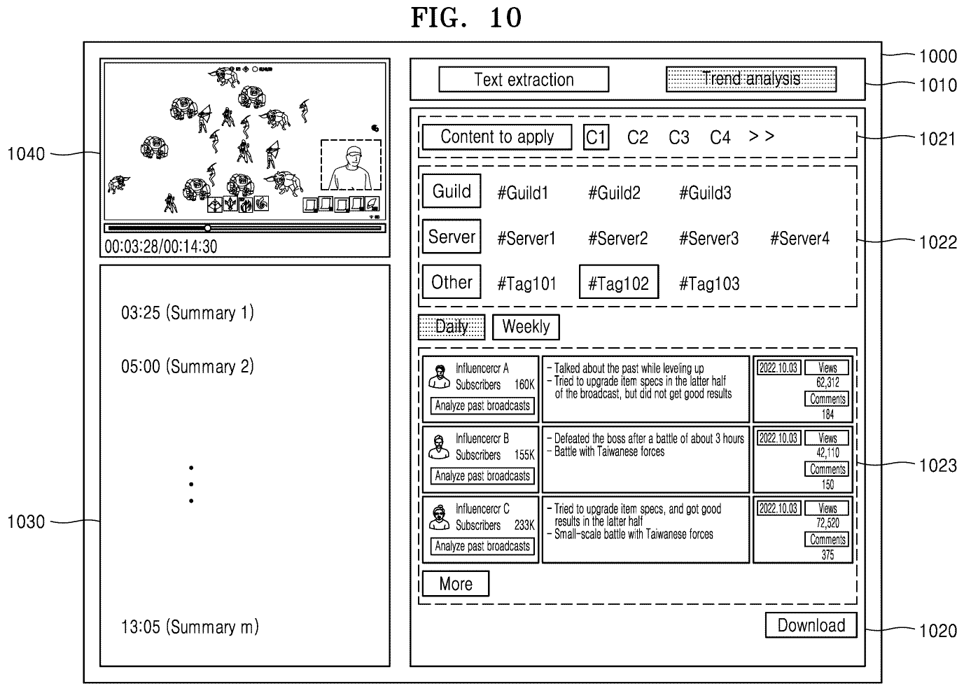

FIG. 10 is a diagram illustrating a trend analysis interface according to an embodiment of the present disclosure.

As described above with reference to FIG. 5, when the selected function is the trend analysis function, the video analysis device may receive an input of tag data and generate trend data, and may generate a trend analysis interface based on the generated trend data.

In an embodiment, a trend analysis interface 1000 may include a function display interface 1010.

In the present disclosure, the function display interface 1010 may refer to an interface configured to allow identification of a function being provided via the displayed interface. The function display interface 1010 included in the trend analysis interface 1000 may be similar to the function display interface 810 described above with reference to FIG. 8, and the description and embodiments regarding the function display interface 810 may be applied as is, and thus, detailed descriptions thereof will be omitted.

In an embodiment, the trend analysis interface 1000 may include a trend data interface 1020.

In the present disclosure, the trend data interface 1020 may refer to an interface configured to display trend data and further configured to provide functions allowing the user of the video analysis device to analyze trend data generated by the video analysis device from various perspectives.

In an embodiment, the trend data interface 1020 may include a category interface 1021.

In the present disclosure, video category classification may be performed on video data. That is, the video analysis device may determine a category to which video data belongs. The video category may be set in any suitable manner depending on the user's purpose for using the video analysis device, the user's intended approach to analyzing the video data, the type of the video data, and the like. For example, the video category may be set based on content with which the video data is associated. As a specific example, the video category may be set based on a plurality of pieces of content (e.g., games or movies) produced by the user of the video analysis device, and video category classification may be performed on the video data depending on which of the plurality of pieces of content the video data is associated with. That is, in a case in which the plurality of pieces of content produced by the user of the video analysis device include a first game, a second game, and a third game, and one piece of video data is associated with the first game among the first game, the second game, and the third game, the one piece of video data may be classified as belonging to a category corresponding to the first game. In addition, in a case in which one piece of video data is associated with any one of a plurality of servers within the first game, the video data may be classified as belonging to a category corresponding to the server, and in a case in which one piece of video data is associated with any one of a plurality of guilds, the video data may be classified as belonging to a category corresponding to the guild.

As described above, keyword data or tag data may be set based on the video category. For example, when the tag data is set based on a video category, the same criteria may be applied to one or more pieces of video data belongs to the same video category, enabling objective and effective trend identification.

In an embodiment, the video analysis device may determine the video category of video data, based on a speech text or text data. For example, a specific word included in the speech text may be detected, and a video category that matches the detected word, among a plurality of video categories, may be determined as the video category of the video data.

In an embodiment, the category interface 1021 may be configured to identify the categories of one or more pieces of video data to be analyzed via the trend data interface 1020. In the example illustrated in FIG. 10, the video data to be analyzed via the trend data interface 1020 may be video data belonging to the category labeled “C1”. The user of the video analysis device may interact with a category object included in the category interface 1021, to change the video data to be analyzed.

In an embodiment, the trend data interface 1020 may include a tag data interface 1022.

In the present disclosure, the tag data interface 1022 may refer to an interface configured to display tag data. The user of the video analysis device may check tag data that has served as the basis for trend data generation via the trend data interface 1020. The user of the video analysis device may utilize, as a filter, a tag object included in the tag data interface 1022. For example, in the example illustrated in FIG. 10, the video data to be analyzed via the trend data interface 1020 may be video data associated with “Tag102”. The user of the video analysis device may interact with a tag object included in the tag data interface 1022, to change the video data to be analyzed.

In an embodiment, one or more tags included in the tag data may be classified according to predetermined criteria, and the tag data interface 1022 may display the tag data based on the classification according to the predetermined criteria.

In an embodiment, the trend data interface 1020 may include a multi-trend interface 1023.

In the present disclosure, the multi-trend interface 1023 may refer to an interface configured to display all trend data generated for each of one or more pieces of video data. The multi-trend interface 1023 included in the trend data interface 1020 may be similar to the multi-trend interface 910 described above with reference to FIG. 9, and the description and embodiments regarding the multi-trend interface 910 may be applied as is, and thus, detailed descriptions thereof will be omitted.

In an embodiment, the trend data interface 1020 may include an object allowing setting of a time range for display of trend data. The user of the video analysis device may interact with the object allowing setting of the time range for display of trend data, to set the period for trend data to be displayed. In the example illustrated in FIG. 10, the trend data interface 1020 displays daily trend data, however, when the user of the video analysis device interacts with the object labeled “Weekly”, the video analysis device may display weekly trend data.

In an embodiment, the trend data interface 1020 may include an object for invoking a download function.

In an embodiment, the user of the video analysis device may download data included in the trend data interface 1020, via the object for invoking the download function. The object for invoking the download function included in the trend data interface 1020 may be similar to the download function invocation object 930 described above with reference to FIG. 9, and the description and embodiments regarding the download function invocation object 930 may be applied as is, and thus, detailed descriptions thereof will be omitted.

In an embodiment, the trend analysis interface 1000 may include a summary data interface 1030.

In the present disclosure, the summary data interface 1030 may refer to an interface configured to display summary data. The summary data interface 1030 included in the trend analysis interface 1000 may be similar to the summary data interface 830 described above with reference to FIG. 8, and the description and embodiments regarding the summary data interface 830 may be applied as is, and thus, detailed descriptions thereof will be omitted.

In an embodiment, the trend analysis interface 1000 may include a video playback interface 1040.

In the present disclosure, the video playback interface 1040 may refer to an interface configured to play back video data. The video playback interface 1040 included in the trend analysis interface 1000 may be similar to the video playback interface 840 described above with reference to FIG. 8, and the description and embodiments regarding the video playback interface 840 may be applied as is, and thus, detailed descriptions thereof will be omitted.

The specific configurations of the interfaces according to various embodiments described above are provided merely as examples, and the types of data displayed and the data display methods may be configured in any suitable manner.

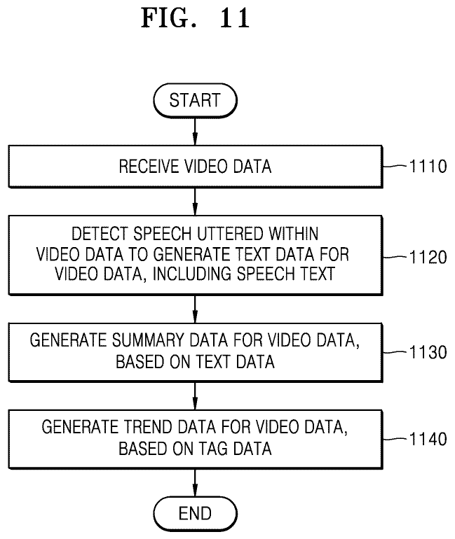

FIG. 11 is a flowchart of a method of extracting and analyzing information from video data, according to an embodiment of the present disclosure.

The operations illustrated in FIG. 11 may be executed by a video analysis device, i.e., a device for extracting and analyzing information from video data. In detail, the operations illustrated in FIG. 11 may be executed by a processor included in a video analysis device, i.e., a device for extracting and analyzing information from video data.

In operation 1110, the video analysis device may receive video data.

In operation 1120, the video analysis device may detect speech uttered within the video data to generate text data for the video data, including a speech text of the video data.

In an embodiment, when the uttered speech is associated with a plurality of speakers, the text data may include information about the speaker corresponding to the speech text among the plurality of speakers.

In operation 1130, the video analysis device may generate summary data for the video data, based on the text data.

In an embodiment, the operation of generating the summary data may include generating the summary data based on keyword data.

In an embodiment, the keyword data may be generated based on one or more words detected in the speech text a threshold number of times or more.

In operation 1140, the video analysis device may generate trend data for the video data, based on tag data.

In an embodiment, the operation, performed by the video analysis device, of generating the trend data may include detecting, in the speech text included in the text data, a word similar to a first tag included in the tag data, generating modified text data by replacing the similar word with the first tag, and generating the trend data for the video data, based on the modified text data.

In an embodiment, the video analysis device may determine a category to which the video data belongs, from among one or more preset video categories.

In an embodiment, the tag data may be set based on the video category of the video data.

In an embodiment, after operation 1130, the video analysis device may generate an interface for displaying information about the video data.

In an embodiment, the interface for displaying the information about the video data may include a text extraction interface.

In an embodiment, the text extraction interface may include a video playback interface configured to play back the video data, a text data interface configured to display the text data, and a summary data interface configured to display the summary data.

In an embodiment, the video playback interface may be configured to, in response to receiving an input of interacting with a first timestamp object included in the text data interface or the summary data interface, play back the video starting from the time point corresponding to the first timestamp object.

In an embodiment, the interface for displaying the information about the video data may include a trend analysis interface.

In an embodiment, the trend analysis interface may include a video playback interface configured to display the video data, a trend data interface configured to display the trend data, and a summary data interface configured to display the summary data.

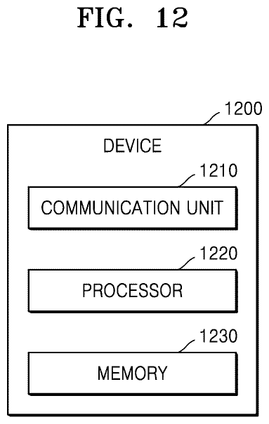

FIG. 12 is a block diagram of a device for extracting and analyzing information from video data, according to an embodiment of the present disclosure.

Referring to FIG. 12, a device 1200 for extracting and analyzing information from video data may include a communication unit 1210, a processor 1220, and a memory 1230. FIG. 12 illustrates the device 1200 for extracting and analyzing information from video data, including only the components associated with an embodiment. Therefore, it would be understood by those of skill in the art that other components may be further included in addition to those illustrated in FIG. 12.

The communication unit 1210 may include one or more components for performing wired/wireless communication with other nodes. For example, the communication unit 1210 may include at least one of a short-range communication unit, a mobile communication unit, and a broadcast receiver.

The memory 1230 is hardware for storing various pieces of data processed inside the device 1200 for extracting and analyzing information from video data, and may store a program for the processor 1220 to perform processing and control. The memory 1230 may store payment information, user information, and the like.

The memory 1230 may include random-access memory (RAM) such as dynamic RAM (DRAM) or static RAM (SRAM), read-only memory (ROM), electrically erasable programmable ROM (EEPROM), a compact disc-ROM (CD-ROM), a Blu-ray or other optical disk storage, a hard disk drive (HDD), a solid-state drive (SSD), or flash memory.

The processor 1220 controls the overall operation of the device 1200 for extracting and analyzing information from video data. For example, the processor 1220 may execute programs stored in the memory 1230 to control the overall operation of an input unit, a display, the communication unit 1210, the memory 1230, and the like. The processor 1220 may execute programs stored in the memory 1230 to control at least some of the operations of the device for extracting and analyzing information from video data described above with reference to FIGS. 1 to 11.

The processor 1220 may be implemented by using at least one of application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, and other electrical units for performing functions.

In an embodiment, the device 1200 for extracting and analyzing information from video data may be a mobile electronic device. For example, the device 1200 for extracting and analyzing information from video data may be implemented as a smart phone, a tablet PC, a PC, a smart TV, a PDA, a laptop computer, a media player, a navigation system, a camera-equipped device, and other mobile electronic devices. In addition, the device 1200 for extracting and analyzing information from video data may be implemented as a wearable device having a communication function and a data processing function, such as a watch, glasses, a hair band, or a ring.

An embodiment of the present disclosure may be implemented as a computer program that may be executed through various components on a computer, and such a computer program may be recorded in a non-transitory computer-readable medium. In this case, the medium may include a magnetic medium, such as a hard disk, a floppy disk, or a magnetic tape, an optical recording medium, such as a compact disc-ROM (CD-ROM) or a digital video disc (DVD), a magneto-optical medium, such as a floptical disk, and a hardware device specially configured to store and execute program instructions, such as ROM, RAM, or flash memory.

In addition, the computer program may be specially designed and configured for the present disclosure or may be well-known to and usable by those skilled in the art of computer software. Examples of the computer program may include not only machine code, such as code made by a compiler, but also high-level language code that is executable by a computer by using an interpreter or the like.

According to an embodiment, the method according to various embodiments of the present disclosure may be included in a computer program product and provided. The computer program product may be traded as commodities between sellers and buyers. The computer program product may be distributed in the form of a machine-readable storage medium (e.g., a CD-ROM), or may be distributed online (e.g., downloaded or uploaded) through an application store (e.g., Play Store™) or directly between two user devices. In a case of online distribution, at least a portion of the computer program product may be temporarily stored in a machine-readable storage medium such as a manufacturer's server, an application store's server, or a memory of a relay server.

What is claimed is:

1. A method of extracting and analyzing information from video data, the method comprising:
obtaining video data;
detecting speech uttered within the video data to generate text data for the video data, the text data comprising a speech text of the video data;
generating summary data for the video data based on the text data;
generating trend data for the video data based on tag data; and
displaying information about the video data.

2. The method of claim 1, further comprising identifying a video category to which the video data belongs, from among one or more preset video categories,
wherein the tag data is set based on the video category to which the video data belongs.

3. The method of claim 1, wherein the generating of the summary data comprises generating the summary data based on keyword data, and
wherein the keyword data is generated based on one or more words detected in the speech text a threshold number of times or more.

4. The method of claim 1, wherein the generating of the trend data comprises:
detecting, in the speech text included in the text data, a word similar to a first tag included in the tag data;
generating modified text data by replacing the similar word with the first tag; and
generating the trend data for the video data based on the modified text data.

5. The method of claim 1, wherein, based on the uttered speech being associated with a plurality of speakers, the text data comprises information about a speaker corresponding to the speech text among the plurality of speakers.

6. The method of claim 1, further comprising generating an interface configured to display the information about the video data.

7. The method of claim 6, wherein the interface for displaying information about the video data comprises a text extraction interface, and
the text extraction interface comprises a video playback interface configured to display the video data, a text data interface configured to display the text data, and a summary data interface configured to display the summary data.

8. The method of claim 7, wherein the video playback interface is configured to, based on obtaining an input of interacting with a first timestamp object included in the text data interface or the summary data interface, play back a video starting from a time point corresponding to the first timestamp object.

9. The method of claim 6, wherein the interface for displaying information about the video data comprises a trend analysis interface, and
the trend analysis interface comprises a video playback interface configured to display the video data, a trend data interface configured to display the trend data, and a summary data interface configured to display the summary data.

10. A non-transitory computer-readable recording medium having recorded thereon a program for causing a computer to execute a method comprising:
obtaining video data;
detecting speech uttered within the video data to generate text data for the video data, the text data comprising a speech text of the video data;
generating summary data for the video data based on the text data; and
generating trend data for the video data based on tag data; and
displaying information about the video data.

11. A device for extracting and analyzing information from video data, the device comprising:
a memory storing at least one instruction; and
a processor configured to execute the at least one instruction to cause the device to:
obtain the video data;
detect speech uttered within the video data to generate text data for the video data, the text data comprising a speech text of the video data;
generate summary data for the video data based on the text data;
generate trend data for the video data based on tag data; and
display information about the video data.

12. The device of claim 11, wherein the processor is further configured to execute the at least one instruction to cause the device to:
identify a video category to which the video data belongs, from among one or more preset video categories, and
wherein the tag data is set based on the video category of the video data.

13. The device of claim 11, wherein the processor is further configured to execute the at least one instruction to cause the device to:
generate the summary data based on keyword data, and
generate the keyword data based on one or more words detected in the speech text a threshold number of times or more.

14. The device of claim 11, wherein the processor is further configured to execute the at least one instruction to cause the device to:
detect, in the speech text included in the text data, a word similar to a first tag included in the tag data; and
generate modified text data by replacing the similar word with the first tag; and
generate the trend data for the video data based on the modified text data.

15. The device of claim 11, wherein, based on the uttered speech being associated with a plurality of speakers, the text data comprises information about a speaker corresponding to the speech text among the plurality of speakers.

16. The device of claim 11, wherein the processor is further configured to execute the at least one instruction to cause the device to generate an interface configured to display the information about the video data.

17. The device of claim 16, wherein the interface for displaying information about the video data comprises a text extraction interface, and
wherein the text extraction interface comprises a video playback interface configured to play back the video data, a text data interface configured to display the text data, and a summary data interface configured to display the summary data.

18. The device of claim 17, wherein the video playback interface is configured to, based on obtaining an input of interacting with a first timestamp object included in the text data interface or the summary data interface, play back a video starting from a time point corresponding to the first timestamp object.

19. The device of claim 16, wherein the interface for displaying information about the video data comprises a trend analysis interface, and
wherein the trend analysis interface comprises a video playback interface configured to display the video data, a trend data interface configured to display the trend data, and a summary data interface configured to display the summary data.
